(19) United States
(12) Patent Application Publication
(10) Pub. No.: US 2014/0301165 A1
(43) Pub. Date: Oct. 9, 2014

(54) SEISMIC DATA PROCESSING USING JOINT TOMOGRAPHY

(71) Applicant: WESTERNGECO L.L.C., HOUSTON, TX (US)

(72) Inventors: DAVID NICHOLS, PALO ALTO, CA (US); MARTA WOODWARD, HOUSTON, TX (US); JOHN C. MATHEWSON, EPSOM (GB)

(73) Assignee: WESTERNGECO L.L.C., HOUSTON, TX (US)

(21) Appl. No.: 14/243,578

(22) Filed: Apr. 2, 2014

Related U.S. Application Data
(60) Provisional application No. 61/808,059, filed on Apr. 3, 2013.

(51) Int. Cl. G01V 1/28

(52) U.S. Cl. CPC G01V 1/282
USPC 367/52

(57) ABSTRACT

Various implementations directed to seismic data processing using joint tomography are provided. In one implementation, a method may include receiving seismic data corresponding to a region of interest. The method may also include generating one or more first gathers and one or more second gathers based on the seismic data. The method may further include determining a relative shift in depth between at least a first event in the one or more first gathers and at least a second event in the one or more second gathers. The method may additionally include performing a joint tomography based at least in part on the first event, the second event, and the determined relative shift.

### CROSS-REFERENCE TO RELATED APPLICATION

This application claims the benefit of U.S. Provisional Patent Application Ser. No. 61/808,059 filed Apr. 3, 2013, which is incorporated herein by reference in its entirety.

### BACKGROUND

In a seismic survey, a plurality of seismic sources, such as explosives, vibrators, air guns, and/or the like, may be sequentially activated near the surface of the earth to generate energy (i.e., seismic waves) which may propagate into and through the earth. The seismic waves may be reflected back by geological formations within the earth, and the resultant seismic wavefield may be sampled by a plurality of seismic receivers, such as geophones, hydrophones and the like. Each receiver may be configured to acquire seismic data at the receiver's location, normally in the form of a seismogram representing the value of some characteristic of the seismic wavefield against time. The acquired seismograms or seismic data may be transmitted wirelessly or over electrical or optical cables to a recorder system. The recorder system may then store, analyze, and/or transmit the seismic data. This data may be used to generate an image of subsurface formations in the earth and may also be used to detect the possible presence of hydrocarbons, changes in the subsurface formations and the like.

In particular, a velocity model may be used to generate images of the subsurface formations. In one scenario, multiple sets of seismic data may be used to build and/or update the velocity model in order to generate images of greater accuracy.

### SUMMARY

Various implementations directed to seismic data processing using joint tomography are provided. In one implementation, a method may include receiving seismic data corresponding to a region of interest. The method may also include generating one or more first gathers and one or more second gathers based on the seismic data. The method may further include determining a relative shift in depth between at least a first event in the one or more first gathers and at least a second event in the one or more second gathers. The method may additionally include performing a joint tomography based at least in part on the first event, the second event, and the determined relative shift.

In another implementation, a method may include receiving seismic data corresponding to a region of interest. The method may also include generating one or more PP gathers and one or more PS gathers based on the seismic data. The method may further include determining a relative shift in depth between at least a PP event in the one or more PP gathers and at least a PS event in the one or more PS gathers. The method may additionally include performing a joint tomography based at least in part on the PP event, the PS event, and the determined relative shift.

In yet another implementation, a non-transitory computer-readable medium may have stored computer-executable instructions which, when executed by a computer, cause the computer to receive seismic data corresponding to a region of interest. The computer-executable instructions may also cause the computer to generate one or more first gathers and one or more second gathers based on the seismic data. The computer-executable instructions may further cause the computer to determine a relative shift in depth between at least a first event in the one or more first gathers and at least a second event in the one or more second gathers. The computer-executable instructions may further cause the computer to perform a joint tomography based at least in part on the first event, the second event, and the determined relative shift.

The above referenced summary section is provided to introduce a selection of concepts in a simplified form that are further described below in the detailed description section. The summary is not intended to be used to limit the scope of the claimed subject matter. Furthermore, the claimed subject matter is not limited to implementations that solve any disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate the various implementations described herein and are not meant to limit the scope of various techniques described herein.

FIGS. 1.1-1.4 illustrate simplified, schematic views of an oilfield having subterranean formation containing reservoir therein in accordance with implementations of various technologies and techniques described herein.

FIG. 2 illustrates a schematic view, partially in cross section of an oilfield having data acquisition tools positioned at various locations along the oilfield for collecting data of a subterranean formation in accordance with implementations of various technologies and techniques described herein.

FIG. 3 illustrates an oilfield for performing production operations in accordance with implementations of various technologies and techniques described herein.

FIG. 4 illustrates a seismic system in accordance with implementations of various technologies and techniques described herein.

FIG. 5 illustrates a flow diagram of a method for updating a velocity model in accordance with implementations of various techniques described herein.

FIG. 6 illustrates a pressure wave moveout pick and a shear wave moveout pick in accordance with implementations of various techniques described herein.

FIG. 7 illustrates a pressure wave moveout pick and a relative shift in depth in accordance with implementations of various techniques described herein.

FIG. 8 illustrates a pressure wave moveout pick and a shear wave moveout pick with their respective updated picks in accordance with implementations of various techniques described herein.

FIG. 9 illustrates a shear wave moveout pick and a relative shift in depth in accordance with implementations of various techniques described herein.

FIG. 10 illustrates a computing system in which various implementations of various techniques described herein may be implemented.

### DETAILED DESCRIPTION

The discussion below is directed to certain specific implementations. It is to be understood that the discussion below is for the purpose of enabling a person with ordinary skill in the art to make and use any subject matter defined now or later by the patent “claims” found in any issued patent herein.

It is specifically intended that the claims not be limited to the implementations and illustrations contained herein, but include modified forms of those implementations including portions of the implementations and combinations of elements of different implementations as come within the scope of the following claims.

Reference will now be made in detail to various implementations, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to obscure aspects of the embodiments.

It will also be understood that, although the terms first, second, etc., may be used herein to describe various elements, these elements should not be limited by these terms. These terms are used to distinguish one element from another. For example, a first object could be termed a second object, and, similarly, a second object could be termed a first object, without departing from the scope of the claims. The first object and the second object are both objects, respectively, but they are not to be considered the same object.

The terminology used in the description of the present disclosure herein is for the purpose of describing particular implementations and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses one or more possible combinations of one or more of the associated listed items. It will be further understood that the terms “includes” and/or “including,” when used in this specification, specify the presence of stated features, integers, operations, elements, and/or components, but do not preclude the presence or addition of one or more other features, integers, operations, elements, components and/or groups thereof.

As used herein, the terms “up” and “down;” “upper” and “lower;” “upwardly” and downwardly;” “below” and “above;” and other similar terms indicating relative positions above or below a given point or element may be used in connection with some implementations of various technologies described herein. However, when applied to equipment and methods for use in wells that are deviated or horizontal, or when applied to equipment and methods that when arranged in a well are in a deviated or horizontal orientation, such terms may refer to a left to right, right to left, or other relationships as appropriate.

It should also be noted that in the development of any such actual implementation, numerous decisions specific to circumstance may be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

The terminology and phraseology used herein is solely used for descriptive purposes and should not be construed as limiting in scope. Language such as “having,” “containing,” or “involving,” and variations thereof, is intended to be broad and encompass the subject matter listed thereafter, equivalents, and additional subject matter not recited.

Furthermore, the description and examples are presented solely for the purpose of illustrating the different embodiments, and should not be construed as a limitation to the scope and applicability. While any composition or structure may be described herein as having certain materials, it should be understood that the composition could optionally include two or more different materials. In addition, the composition or structure may also include some components other than the ones already cited. It should also be understood that throughout this specification, when a range is described as being useful, or suitable, or the like, it is intended that any value within the range, including the end points, is to be considered as having been stated. Furthermore, respective numerical values should be read once as modified by the term “about” (unless already expressly so modified) and then read again as not to be so modified unless otherwise stated in context. For example, “a range of from 1 to 10” is to be read as indicating a respective possible number along the continuum between about 1 and about 10. In other words, when a certain range is expressed, even if a few specific data points are explicitly identified or referred to within the range, or even when no data points are referred to within the range, it is to be understood that the inventors appreciate and understand that any data points within the range are to be considered to have been specified, and that the inventors have possession of the entire range and points within the range.

As used herein, the term “if” may be construed to mean “when” or “upon” or “in response to determining” or “in response to detecting,” depending on the context.

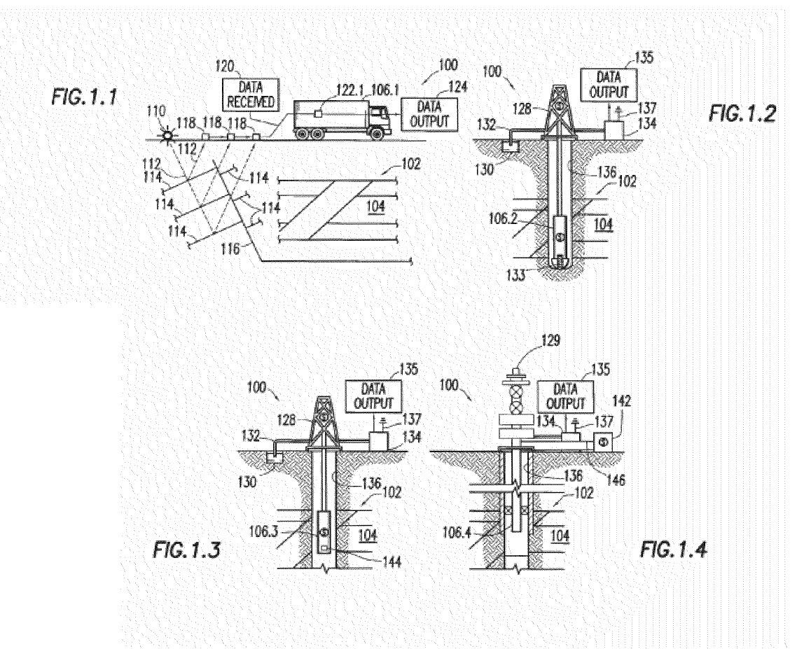

One or more implementations of various techniques for seismic data processing using joint tomography will now be described in more detail with reference to FIGS. 1-10 in the following paragraphs.

### Oilfield Environment

FIGS. 1.1-1.4 illustrate simplified, schematic views of oilfield 100 having subterranean formation 102 containing reservoir 104 therein, in accordance with implementations of various technologies and techniques described herein. FIG. 1.1 illustrates a survey operation being performed by a survey tool, such as seismic truck 106.1, to measure properties of the subterranean formation. The survey operation may be a seismic survey operation for producing sound vibrations. In FIG. 1.1, one such sound vibration, e.g., sound vibration 112 generated by source 110, may reflect off horizons 114 in earth formation 116. A set of sound vibrations may be received by sensors, such as geophone-receivers 118, situated on the earth's surface. The data received 120 may be provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 1.2 illustrates a drilling operation being performed by drilling tools 106.2 suspended by rig 128 and advanced into subterranean formations 102 to form wellbore 136. Mud pit 130 may be used to draw drilling mud into the drilling tools via flow line 132 for circulating drilling mud down through the drilling tools, then up wellbore 136 and back to the surface. The drilling mud may be filtered and returned to the mud pit. A circulating system may be used for storing, controlling, or filtering the flowing drilling mud. The drilling tools may be advanced into subterranean formations 102 to reach reservoir 104. Each well may target one or more reservoirs. The drilling tools may be adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 may be capable of communicating with the drilling tools to send commands to the drilling tools, and to receive data therefrom. Surface unit 134 may also collect data generated during the drilling operation and produce data output 135, which may then be stored or transmitted.

Sensors (S), such as gauges, may be positioned about oilfield 100 to collect data relating to various oilfield operations as described previously. As shown, sensor (S) may be positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly may include capabilities for measuring, processing, and storing information, as well as communicating with surface unit 134. The bottom hole assembly may further include drill collars for performing various other measurement functions.

The bottom hole assembly may include a communication subassembly that communicates with surface unit 134. The communication subassembly may be adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It may be appreciated by one of skill in the art that a variety of telemetry systems may be employed, such as wired drill pipe, electromagnetic or other known telemetry systems.

The wellbore may be drilled according to a drilling plan that is established prior to drilling. The drilling plan may set forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected.

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize portions of the field operation, such as controlling drilling, weight on bit, pump rates, or other parameters. These adjustments may be made automatically based on computer protocol, and/or manually by an operator. In some cases, well plans may be adjusted to select optimum operating conditions, or to avoid problems.

FIG. 1.3 illustrates a wireline operation being performed by wireline tool 106.3 suspended by rig 128 and into wellbore 136 of FIG. 1.2. Wireline tool 106.3 may be adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 1.1. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S may be positioned in wireline tool 106.3 to measure downhole parameters which relate to, for example porosity, permeability, fluid composition and/or other parameters of the field operation.

FIG. 1.4 illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1.2-1.4 illustrate tools used to measure properties of an oilfield, it may be appreciated that the tools may be used in connection with non-oilfield operations, such as gas fields, mines, aquifers, storage, or other subterranean facilities. Also, while certain data acquisition tools are depicted, it may be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 1.1-1.4 may be an example of a field usable with oilfield application frameworks. At least part of oilfield 100 may be on land, water, and/or sea. Also, while a single field measured at a single location may be depicted, oilfield applications may be utilized with any combination of one or more oilfields, one or more processing facilities and one or more wellsites.

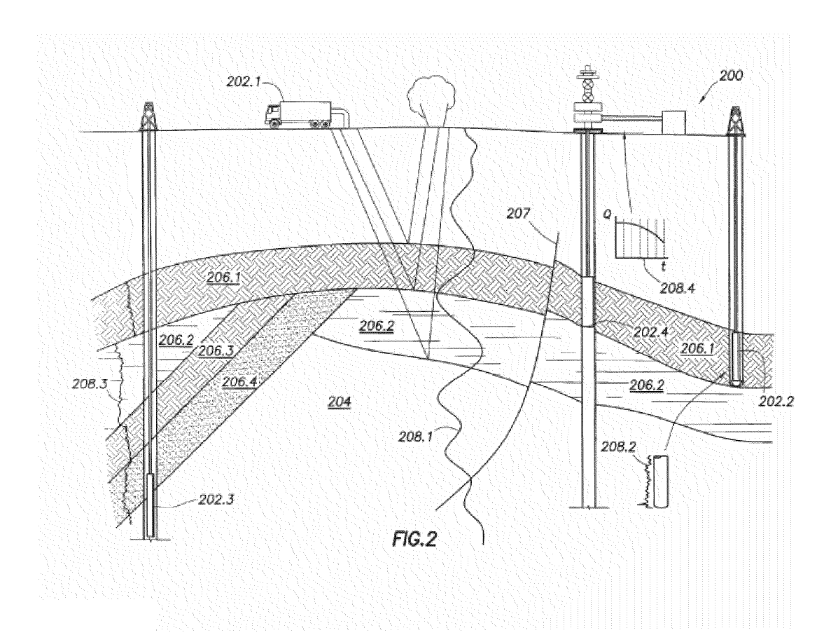

FIG. 2 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 1.1-1.4, respectively, or others not depicted. As shown, data acquisition tools 202.1-202.4 may generate data plots or measurements 208.1-208.4, respectively. These data plots may be depicted along oilfield 200 to demonstrate the data generated by the various operations.

Data plots 208.1-208.3 may be examples of static data plots that may be generated by data acquisition tools 202.1-202.3, respectively; however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 may be a seismic two-way response over a period of time. Static plot 208.2 may be core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 may be a logging trace that may provide a resistivity or other measurement of the formation at various depths.

A production decline curve or graph 208.4 may be a dynamic data plot of the fluid flow rate over time. The production decline curve may provide the production rate as a function of time. As the fluid flows through the wellbore, measurements may be taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 may have a plurality of geological formations 206.1-206.4. As shown, this structure may have several formations or layers, including a shale layer 206.1, a carbonate layer 206.2, a shale layer 206.3 and a sand layer 206.4. A fault 207 may extend through the shale layer 206.1 and the carbonate layer 206.2. The static data acquisition tools may be adapted to take measurements and detect characteristics of the formations.

While a specific subterranean formation with specific geological structures is depicted, it may be appreciated that oilfield 200 may contain a variety of geological structures and/or formations, sometimes having extreme complexity. In some locations, such as below the water line, fluid may occupy pore spaces of the formations. Each of the measurement devices may be used to measure properties of the formations and/or its geological features. While each acquisition tool may be shown as being in specific locations in oilfield 200, it may be appreciated that one or more types of measurement may be taken at one or more locations across one or more fields or other locations for comparison and/or analysis.

The data collected from various sources, such as the data acquisition tools of FIG. 2, may then be processed and/or evaluated. The seismic data displayed in static data plot 208.1 from data acquisition tool 202.1 may be used by a geophysicist to determine characteristics of the subterranean formations and features. The core data shown in static plot 208.2 and/or log data from well log 208.3 may be used by a geologist to determine various characteristics of the subterranean formation. The production data from graph 208.4 may be used by the reservoir engineer to determine fluid flow reservoir characteristics. The data analyzed by the geologist, geophysicist and the reservoir engineer may be analyzed using modeling techniques.

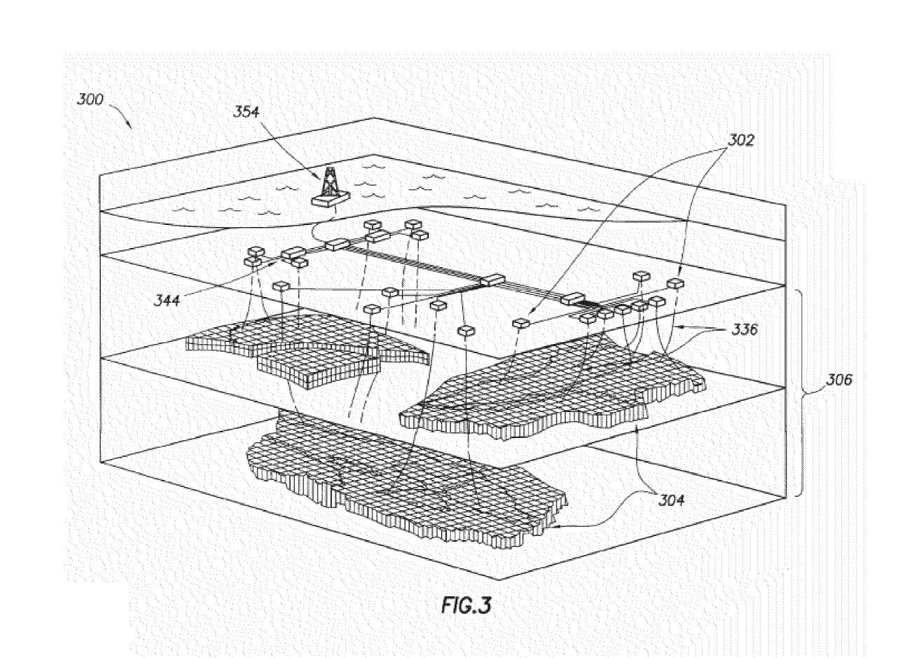

FIG. 3 illustrates an oilfield 300 for performing production operations in accordance with implementations of various technologies and techniques described herein. As shown, the oilfield may have a plurality of wellsites 302 operatively connected to central processing facility 354. The oilfield configuration of FIG. 3 may not be intended to limit the scope of the oilfield application system. At least part of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 may have equipment that forms wellbore 336 into the earth. The wellbores may extend through subterranean formations 306 including reservoirs 304. These reservoirs 304 may contain fluids, such as hydrocarbons. The wellsites may draw fluid from the reservoirs and pass them to the processing facilities via surface networks 344. The surface networks 344 may have tubing and control mechanisms for controlling the flow of fluids from the wellsite to processing facility 354.

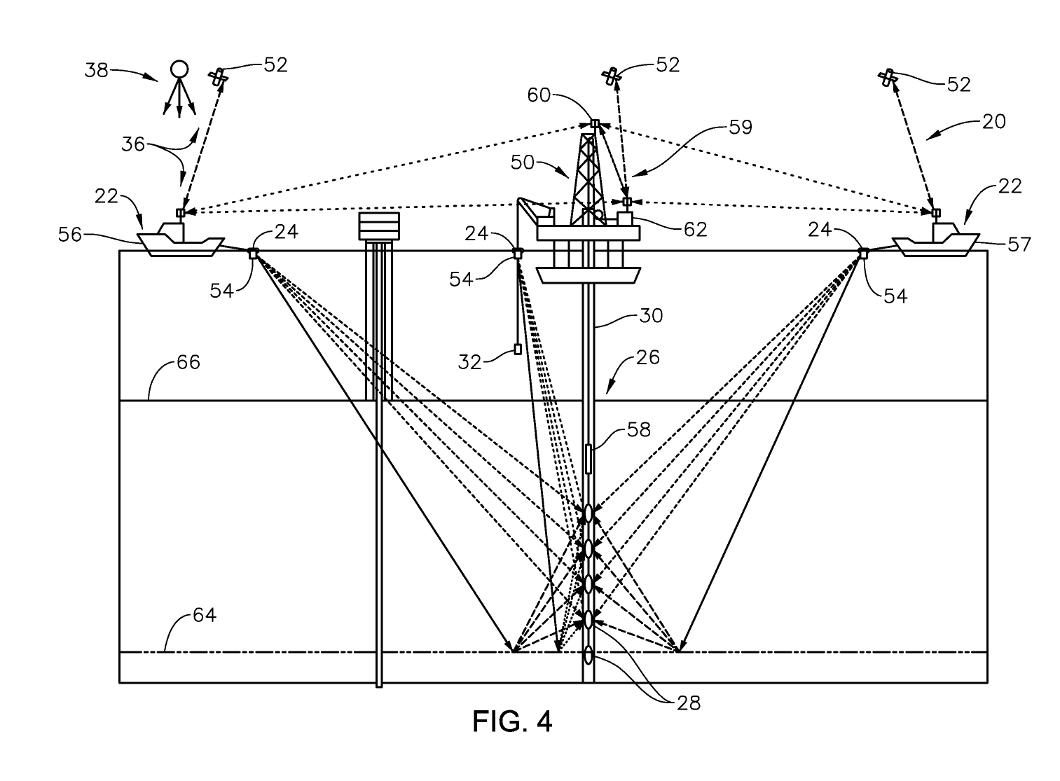

FIG. 4 illustrates a seismic system 20 in accordance with implementations of various technologies and techniques described herein. The seismic system 20 may include a plurality of tow vessels 22 that are employed to enable seismic profiling, e.g., three-dimensional vertical seismic profiling or rig/offset vertical seismic profiling. In FIG. 4, a marine system may include a rig 50, a plurality of vessels 22, and one or more acoustic receivers 28. Although a marine system is illustrated, other implementations of the disclosure may not be limited to this example. A person of ordinary skill in the art may recognize that land or offshore systems may be used.

Although two vessels 22 are illustrated in FIG. 4, a single vessel 22 with multiple source arrays 24 or multiple vessels 22 with single or multiple sources 24 may be used. In some implementations, at least one source and/or source array 24 may be located on the rig 50, as shown by the rig source in FIG. 4. As the vessels 22 travel on predetermined or systematic paths, their locations may be recorded through the use of navigation system 36. In some implementations, the navigation system 36 may utilize a global positioning system (GPS) 38 to record the position, speed, direction, and other parameters of the tow vessels 22.

As shown, the global positioning system 38 may utilize or work in cooperation with satellites 52 which operate on a suitable communication protocol, e.g., VSAT communications. The VSAT communications may be used, among other things, to supplement VHF and UHF communications. The GPS information can be independent of the VSAT communications and may be input to processing system 46 or other suitable processors to predict the future movement and position of the vessels 22 based on real-time information. In addition to predicting future movements, the processing system 46 also can be utilized to provide directions and coordinates as well as to determine initial shot times, as described above. Control system 34 effectively utilizes processing system 46 in cooperation with source controller 42 and synchronization unit 44 to synchronize the sources 24 with the downhole data acquisition system 26.

As shown, the one or more vessels 22 may respectively tow one or more acoustic sources/source arrays 24. The source arrays 24 include one or more seismic signal generators 54, e.g., air guns, configured to create a seismic and/or sonic disturbance. In the implementation illustrated, the tow vessels 22 comprise a master source vessel 56 (Vessel A) and a slave source vessel 57 (Vessel B). However, other numbers and arrangements of tow vessels 22 may be employed to accommodate the parameters of a given seismic profiling application. For example, one source 24 may be mounted at rig 50 (see FIG. 4) or at another suitable location, and both vessels 22 may serve as slave vessels with respect to the rig source 24 or with respect to a source at another location.

However, a variety of source arrangements and implementations may be used. When utilizing dithered timing between the sources, for example, the master and slave locations of the sources can be adjusted according to the parameters of the specific seismic profiling application. In some implementations, one of the source vessels 22 (e.g., source vessel A in FIG. 4) may serve as the master source vessel while the other source vessel 22 serves as the slave source vessel with dithered firing. However, an alternate source vessel 22 (e.g., source vessel B in FIG. 4) may serve as the master source vessel while the other source vessel 22 serves as the slave source vessel with dithered firing.

Similarly, the rig source 22 may serve as the master source while one of the source vessels 22 (e.g., vessel A) serves as the slave source vessel with dithered firing. The rig source 22 also may serve as the master source while the other source vessel 22 (e.g., vessel B) serves as the slave source vessel with dithered firing. In some implementations, the rig source 22 may serve as the master source while both of the source vessels 22 serve as slave source vessels each with dithered firings. These and other implementations may be used in achieving the desired synchronization of sources 22 with the downhole acquisition system 26.

The acoustic receivers 28 of data acquisition system 26 may be deployed in borehole 30 via a variety of delivery systems, such as wireline delivery systems, slickline delivery systems, and other suitable delivery systems. Although a single acoustic receiver 28 could be used in the borehole 30, a plurality of receivers 28, as shown, may be located in a variety of positions and orientations. The acoustic receivers 28 may be configured for sonic and/or seismic reception. Additionally, the acoustic receivers 28 may be communicatively coupled with processing equipment 58 located downhole. In one implementation, processing equipment 58 may comprise a telemetry system for transmitting data from acoustic receivers 28 to additional processing equipment 59 located at the surface, e.g., on the rig 50 and/or vessels 22.

Depending on the data communication system, surface processing equipment 59 may include a radio repeater 60, an acquisition and logging unit 62, and a variety of other and/or additional signal transfer components and signal processing components. The radio repeater 60 along with other components of processing equipment 59 may be used to communicate signals, e.g., UHF and/or VHF signals, between vessels 22 and rig 50 and to enable further communication with downhole data acquisition system 26.

It should be noted the UHF and VHF signals can be used to supplement each other. The UHF band may support a higher data rate throughput, but can be susceptible to obstructions and has less range. The VHF band may be less susceptible to obstructions and may have increased radio range but its data rate throughput is lower. In FIG. 4, the VHF communications may “punch through” an obstruction in the form of a production platform.

In some implementations, the acoustic receivers 28 may be coupled to surface processing equipment 59 via a hardwired connection. In other implementations, wireless or optical connections may be employed. In still other implementations, combinations of coupling techniques may be employed to relay information received downhole via the acoustic receivers 28 to an operator and/or control system, e.g., control system 34, located at least in part at the surface.

In addition to providing raw or processed data uphole to the surface, the coupling system, e.g., downhole processing equipment 58 and surface processing equipment 59, may be designed to transmit data or instructions downhole to the acoustic receivers 28. For example, the surface processing equipment 59 may comprise synchronization unit 42, which may coordinate the firing of sources 24, e.g., dithered (delayed) source arrays, with the acoustic receivers 28 located in borehole 30. In one implementation, the synchronization unit 42 may use coordinated universal time to ensure accurate timing. In some implementations, the coordinated universal time system 40 may be employed in cooperation with global positioning system 38 to obtain UTC data from the GPS receivers of GPS system 38.

FIG. 4 illustrates one example of a system for performing seismic profiling that can employ simultaneous or near-simultaneous acquisition of seismic data. In one implementation, the seismic profiling may comprise three-dimensional vertical seismic profiling, but other applications may utilize rig and/or offset vertical seismic profiling or seismic profiling employing walkaway lines. An offset source can be provided by a source 24 located on rig 50, on a stationary vessel 22, and/or on another stationary vessel or structure.

In one implementation, the overall seismic system 20 may employ various arrangements of sources 24 on vessels 22 and/or rig 50 with each location having at least one source and/or source array 24 to generate acoustic source signals. The acoustic receivers 28 of downhole acquisition system 26 may be configured to receive the source signals, at least some of which are reflected off a reflection boundary 64 located beneath a sea bottom 36. The acoustic receivers 28 may generate data streams that are relayed uphole to a suitable processing system, e.g., processing system 46, via downhole telemetry/processing equipment 58.

While the acoustic receivers 28 generate data streams, the navigation system 36 may determine a real-time speed, position, and direction of each vessel 22 and may estimate initial shot times accomplished via signal generators 54 of the appropriate source arrays 24. The source controller 42 may be part of surface processing equipment 59 (located on rig 50, on vessels 22, or at other suitable locations) and may be designed to control firing of the acoustic source signals so that the timing of an additional shot time (e.g., a shot time via slave vessel 57) is based on the initial shot time (e.g., a shot time via master vessel 56) plus a dither value.

The synchronization unit 44 of, for example, surface processing equipment 59, may coordinate the firing of dithered acoustic signals with recording of acoustic signals by the downhole acquisition system 26. Processor system 46 may be configured to separate a data stream of the initial shot and a data stream of the additional shot via the coherency filter 48. As discussed above, however, other implementations may employ pure simultaneous acquisition and/or may not use separation of the data streams. In such implementations, the dither is effectively zero.

After an initial shot time at T=0 (T0) is determined, subsequent firings of acoustic source arrays 24 may be offset by a dither. The dithers can be positive or negative and sometimes are created as pre-defined random delays. Use of dithers facilitates the separation of simultaneous or near-simultaneous data sets to simplify the data processing. The ability to have the acoustic source arrays 24 fire in simultaneous or near-simultaneous patterns may reduce the overall amount of time for three-dimensional vertical seismic profiling source acquisition. This, in turn, may significantly reduce rig time. As a result, the overall cost of the seismic operation may be reduced, rendering the data intensive process much more accessible.

If the acoustic source arrays used in the seismic data acquisition are widely separated, the difference in move-outs across the acoustic receiver array of the wave fields generated by the acoustic sources 24 can be used to obtain a clean data image via processing the data without further special considerations. However, even when the acoustic sources 24 are substantially co-located in time, data acquired by any of the methods involving dithering of the firing times of the individual sources 24 described herein can be processed to a formation image leaving hardly any artifacts in the final image. This is accomplished by taking advantage of the incoherence of the data generated by one acoustic source 24 when seen in the reference time of the other acoustic source 24.

Attention is now directed to methods, techniques, and workflows for processing and/or transforming collected data that are in accordance with some implementations. Some operations in the processing procedures, methods, techniques, and workflows disclosed herein may be combined and/or the order of some operations may be changed. In the geosciences and/or other multi-dimensional data processing disciplines, various interpretations, sets of assumptions, and/or domain models such as velocity models, may be refined in an iterative fashion; this concept may be applicable to the procedures, methods, techniques, and workflows as discussed herein. This iterative refinement can include use of feedback loops executed on an algorithmic basis, such as via a computing system, as discussed later, and/or through manual control by a user who may make determinations regarding whether a given action, template, or model has become accurate.

### Seismic Data Processing

As described above with respect to FIGS. 1.1-4, various implementations may be used to acquire seismic data for one or more regions of interest. As further discussed below, the acquired seismic data may be processed to generate one or more images of the regions of interest. In particular, a velocity model updated using the acquired seismic data may be used to produce such images. In one implementation, the velocity model may be updated using a tomography process.

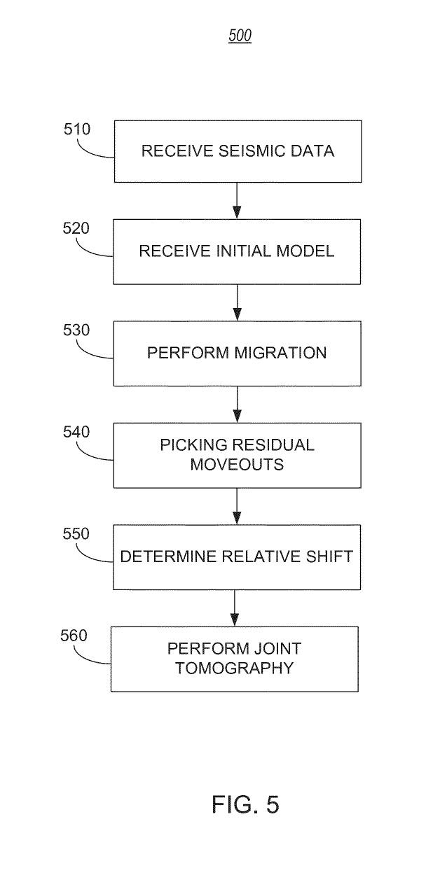

FIG. 5 illustrates a flow diagram of a method 500 for updating a velocity model in accordance with implementations of various techniques described herein. In one implementation, method 500 may be performed by a computer application. It should be understood that while method 500 indicates a particular order of execution of operations, in some implementations, certain portions of the operations might be executed in a different order. Further, in some implementations, additional operations or blocks may be added to the method. Likewise, some operations or blocks may be omitted.

At block 510, seismic data for a region of interest may be received. The region of interest may include one or more subterranean formations or other areas of a subsurface of the earth that may be of particular interest. For example, the region of interest may include one or more geological formations, reservoirs, and/or the like that may possibly contain hydrocarbons.

The seismic data may be obtained and/or received using any implementation known to those skilled in the art, such as the one or more implementations discussed above with respect to FIGS. 1.1-4. The seismic data may include one or more seismic traces recorded by one or more receivers (e.g., geophone-receiver 118 shown in FIG. 1.1). A seismic trace may refer to the seismic data recorded by a particular channel of a data acquisition system, where the channel can correspond to one receiver or a group of receivers. Further, the received seismic data may contain responses from one or more “events,” where the events correspond to reflections of acoustic energy at interfaces such as the horizon 114 shown in FIG. 1.1.

In one implementation, two or more sets of seismic data may be received for the region of interest. In such an implementation, the two or more sets of seismic data may include a set of pressure wave (or P-wave) data and/or a set of shear wave (or S-wave) data. Acoustic energy emitted by a seismic source (e.g., source 110 of FIG. 1.1) may predominantly be one or more P-waves. When the acoustic energy undergoes reflection at an interface, these waves may also undergo a partial mode conversion to one or more S-wave. Thus, the seismic data acquired at a receiver may contain both P-waves and S-waves.

Events arising from arrival of P-waves may be referred to as PP events, as they may involve acoustic energy emitted as a P-wave and recorded on a receiver as a P-wave. Events arising from arrival of S-waves may be referred to as PS events, as they may involve acoustic energy emitted as a P-wave that may undergo a mode conversion to an S-wave upon reflection, such that the acoustic energy may be recorded on the receiver as an S-wave. PP events may occur more prominently in vertical components of the received seismic data, whereas PS events may appear more prominently in the horizontal components. P-wave data may be referred to as PP data, and S-wave data may be referred to as PS data.

In another implementation, the two or more sets of seismic data may include a set of vertical seismic profile (VSP) data and/or a set of surface seismic data. VSP data may refer to measurement made in a wellbore, such as by using receivers inside the wellbore and a source at the surface near a well. Surface seismic data may refer to data acquired using receivers positioned on the surface of the earth.

In yet another implementation, the two or more sets of seismic data may include a set of first time lapse data and a set of second time lapse data. Time lapse data may refer to seismic data acquired during different times of a seismic survey. For example, the first time lapse data may have been acquired from the region of interest during a seismic survey but prior to having produced any hydrocarbons. In such an example, the second time lapse data may have been acquired from the region of interest during the seismic survey but after hydrocarbons have been produced from the region. The second time lapse data and the first time lapse data may be different due to changes in the region resulting from the production of hydrocarbons, such as changes caused by stresses on an overburden. In yet another implementation, the two or more sets of seismic data may include any combination of the above-described sets of data.

At block 520, an initial model may be received for the region of interest. In one implementation, the initial model may be a velocity model and/or an anisotropic model that describes the region of interest. For instance, the initial model may be an anisotropic velocity model which represents one or more acoustic velocities of wave propagation in the region of interest. In particular, this initial anisotropic velocity model may be modeled using parameters such as a P-wave velocity (Vp), an S-wave velocity (Vs), and/or Thomsen parameters such as ε and δ. In another implementation, the initial model may be created using available information, such as well data or velocity data from prior seismic surveys performed in the region of interest.

At block 530, a migration may be performed on the received seismic data. In one implementation, a prestack depth migration (PSDM) may be performed on the received seismic data. The PSDM may be performed using any migration technique known to those skilled in the art, such as reverse time migration (RTM), Kirchhoff depth migration, Gaussian beam migration, wave-equation migration, and/or the like. An output of the migration may include one or more data records (i.e., seismic traces) gathered at a common surface location of image. A collection of traces, either input or output, with a common attribute, such as source location or migrated output location, may be referred to as a gather.

In one implementation, the PSDM may be performed on each set of seismic data received for the region of interest in conjunction with the initial model, such as the initial anisotropic velocity model. In particular, performing the PSDM may generate one or more gathers for each set of seismic data. For example, a PSDM performed on a first set of seismic data may produce a first set of gathers, and a PSDM performed on a second set of seismic data may produce a second set of gathers.

In a further implementation, the PSDM may generate one or more common-image point gathers for each set of seismic data, where a common image point (CIP) gather may correspond to seismic traces with migrated amplitudes gathered together with respect to the same subsurface image point. The CIP gather may be an offset domain CIP gather or an angle domain CIP gather.

In one example, by using the set of PP data in conjunction with the initial anisotropic velocity model, the PSDM may produce one or more PP CIP gathers. Similarly, the PSDM may produce one or more PS CIP gathers using the set of PS data in conjunction with the initial anisotropic velocity model. In particular, the PP CIP gathers may contain a plurality of seismic traces for a particular interface, where each seismic trace corresponds to a PP event at the interface. Similarly, the PS CIP gather may contain a plurality of seismic traces for a particular interface, where each seismic trace corresponds to a PS event at the interface. The CIP gathers may, in effect, provide images of the subsurface interfaces where the events of its traces may have occurred.

In one implementation, the gathers may be plotted with respect to a horizontal axis and a vertical axis. The horizontal axis may denote a source-receiver distance h (also known as offset), with the offset increasing from a left to right direction. The farthest left point of the horizontal axis may be referred to as the zero-offset, where the zero-offset corresponds to a location where a source and a receiver are co-incident. The vertical axis may denote a depth z of the interface where an event occurred, with values of z increasing in a downward direction.

In another implementation, events of the gathers may curve in an upward or downward direction as the offset increases. Curved events of a gather may incorrectly indicate that the interfaces represented by the curved events may each contain differing apparent depths. The curved events may be caused by an inaccurate migration velocity derived from the initial model. For example, events of a PP CIP gather may curve upward if the migration velocity is too slow, and events of the PP CIP gather may curve downward if the migration velocity is too fast. These changes in depth for events of a gather, caused by the inaccurate migration velocity, may be referred to as residual moveout. To compensate for the curvature of the curved events, a correction for residual moveout may be performed on the gather, as further described below. If the migration velocity were accurate, however, then events of a CIP gather may be substantially flat as offset increases.

At block 540, a picking of residual moveouts for events of the two or more sets of seismic data may be performed. In particular, the picking of residual moveouts may be performed on the first set of gathers and the second set of gathers.

As noted earlier, a residual moveout may refer to the changes in depth for events of a gather. A picking process, such as using one or more manual picking and/or automatic picking techniques as known in the art, may be used to obtain and/or estimate the residual moveouts for the events. These residual moveouts for the events may be referred to as moveout picks. In one implementation, the picking process may choose one or more best-fit curves which may approximate the residual moveouts for the events of the gather.

In one implementation, the picking process may produce one or more moveout picks for a first set of CIP gathers, such as for the one or more PP CIP gathers. These moveout picks may be referred to as PP moveout picks. The picking process may also produce one or more moveout picks for a second set of CIP gathers, such as for the one or more PS CIP gathers. These moveout picks may be referred to as PS moveout picks.

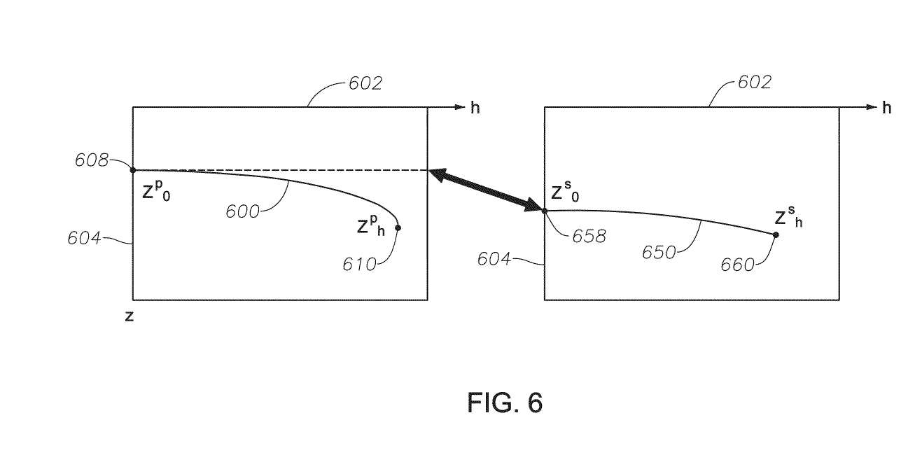

FIG. 6 illustrates a PP moveout pick 600 and a PS moveout pick 650 in accordance with implementations of various techniques described herein. The PP moveout pick 600 may represent a residual moveout for one or more PP events of a PP CIP gather, and the PS moveout pick 650 may represent a residual moveout for one or more PS events of a PS CIP gather. The farthest left point of the PP moveout pick 600 may represent a PP event plotted at a zero-offset depth z^{p}₀, and the farthest right point 610 of the PP moveout pick 600 may represent a PP event plotted at a finite-offset depth z^{p}ₕ. Similarly, the farthest left point 658 of the PS moveout pick 650 may be plotted at a zero-offset depth z^{s}₀, and the farthest right point 660 of the PS moveout pick 650 may be plotted at a finite-offset depth z^{s}ₕ. Note that for depths of the events, the p superscript indicates a depth for a PP event, the s superscript indicates a depth for a PS event, the 0 subscript indicates a depth at an offset of zero, and the h subscript indicates a depth at an offset of h.

In another implementation, as further described below, upon determining the moveout picks, the moveout picks may be sent to a tomography process.

At block 550, a relative shift in depth between events of the two or more sets of seismic data may be determined. In one implementation, the relative shift in depth may be determined between at least one event in the first set of gathers and at least one event in the second set of gathers.

In one implementation, the relative shift in depth may be determined by initially identifying corresponding events among the first set and the second set of gathers. An event in the first set of gathers may correspond to an event in the second set of gathers if both events involve a reflection at the same interface and were both acquired using the same receiver (i.e., have the same offset). In a further implementation, a user may identify such a pair of corresponding events by automatically or manually interpreting the first and second sets of gathers to identify the same interface in both sets of gathers, using any technique and/or method known to those skilled in the art.

Once the corresponding events are identified, the relative shift in depth between the corresponding events may be determined and then sent to a tomography process, as further described below. For example, returning to FIG. 6, an event plotted at point 608, and having a depth z^{p}₀, may correspond to an event plotted at point 658 having a depth z^{s}₀. In such an example, the relative shift in depth between the two events may be the difference between z^{s}₀ and z^{p}₀, where the difference may be sent to a tomography process.

In another implementation, a relative shift in depth between at least one event in a first set of CIP gathers and at least one event in a second set of CIP gathers may be determined automatically using an image displacement algorithm, such as a non-rigid matching (NRM) algorithm or any other implementation known to those skilled in the art. Once the relative shift in depth has been determined using the algorithm, the relative shift may be sent to a tomography process, as further described below.

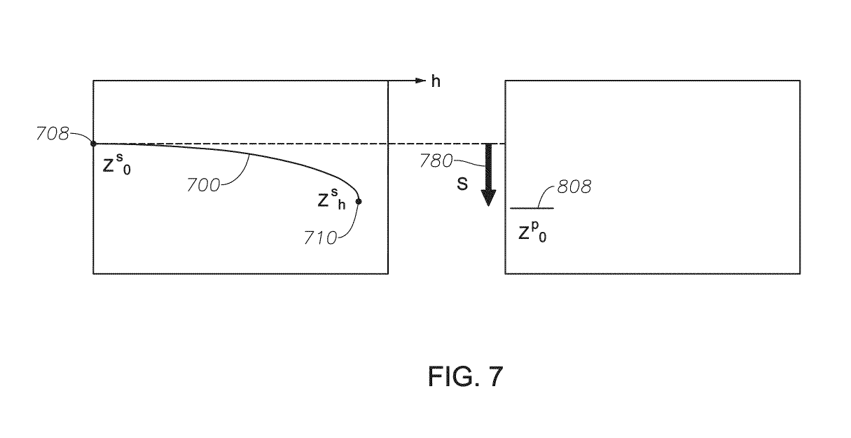

In one implementation, the relative shift in depth determined via the image displacement algorithm may be used with an event in the first set of CIP gathers, such that a depth of a corresponding hypothetical event in the second set of CIP gathers may be identified. FIG. 7 illustrates a PS moveout pick 700 and a relative shift in depth (S) 780 in accordance with implementations of various techniques described herein. A farthest left point 708 of the PS moveout pick 700 may represent a PS event plotted at a zero-offset depth z^{s}₀. Accordingly, a depth z^{p}₀ of a hypothetical corresponding PP event 808 of a PP moveout pick (not shown) may be determined by adding a relative shift (S) 780 to the depth z^{s}₀.

At block 560, a joint tomography process may be performed based on events of the two or more sets of seismic data and the relative shift in depth between the events. In particular, the joint tomography may be performed using moveout picks from a first set of gathers, moveout picks from a second set of gathers, and the relative shift in depth for the events of these sets of gathers. As described below, the joint tomography process may be used to update the initial model received for the region of interest. In particular, joint tomography may be performed to produce a substantially flat first set of gathers, a substantially flat second set of gathers, and for these substantially flat updated sets of gathers to be imaged at substantially the same depth.

In one implementation, a joint tomography process may be used to produce one or more updated picks for a set of gathers, where the updated picks may include depth-shifted events of the moveout picks described above. In addition, the updated picks may be substantially flat for a given depth as offset increases.

In such an implementation, the joint tomography process may estimate depth shifts of one or more events of a moveout pick, such that the depth shifts may be applied to the moveout pick to obtain the substantially flat updated pick. In a further implementation, the updated pick may be obtained by shifting the moveout pick by varying amounts of depth. Such an implementation may be referred to as a floating event formulation.

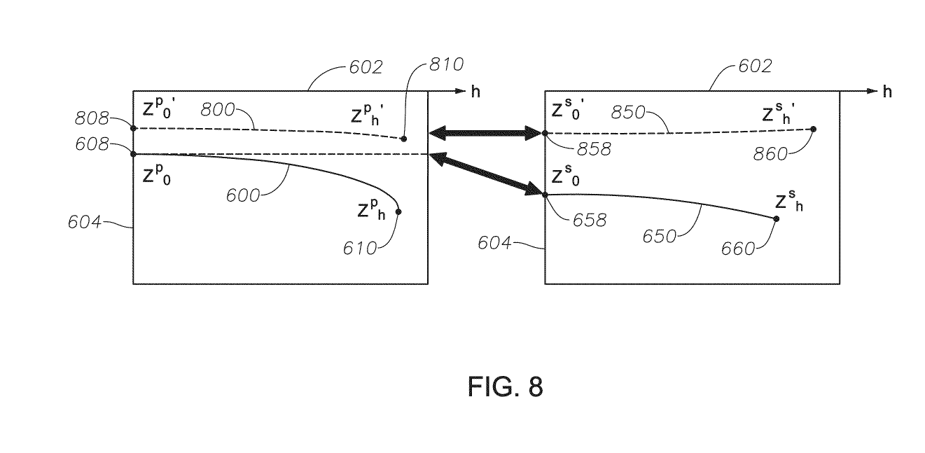

FIG. 8 illustrates the PP moveout pick 600 and the PS moveout pick 650 with their respective updated picks in accordance with implementations of various techniques described herein. A shown, the joint tomography process may produce an updated PP pick 800 for the PP moveout pick 600. In particular, the updated PP pick 800 may be depth-shifted, such that the updated PP pick 800 may be substantially flat as the offset increases. The farthest left point 808 of the updated PP pick 800 may represent an update to the PP event at point 608, such that the point 808 may be plotted at an updated zero-offset depth z^{p}₀′. Similarly, the farthest right point 810 of the updated PP pick 800 may represent an update to the PP event at point 610, such that the point 810 may be plotted at an updated finite-offset depth z^{p}ₕ′.

The joint tomography process may similarly produce an updated PS pick 850 for the PS moveout pick 650. The farthest left point 858 of the updated PS pick 850 may represent an update to the PS event at point 658, such that the point 858 may be plotted at an updated zero-offset depth z^{s}₀′. Similarly, the farthest right point 860 of the updated PS pick 850 may represent an update to the PS event at point 660, such that the point 860 may be plotted at an updated finite-offset depth z^{s}ₕ′.

In particular, the updated PP pick 800 may be constrained by the joint tomography process to be substantially flat, such that a difference in depth between the point 808 plotted at the updated zero-offset depth z^{p}₀′ and the point 810 plotted at the updated finite-offset depth z^{p}ₕ′ may be minimized. In addition, the updated PS gather 850 may be constrained by the joint tomography process to be substantially flat, such that a difference in depth between the point 858 plotted at the updated zero-offset depth z^{s}₀′ and the point 860 plotted at the updated finite-offset depth z^{s}ₕ′ may be minimized. Furthermore, the updated PP gather 800 and the updated PS gather 850 may be constrained by the joint tomography process to be aligned with one another, such that the updated zero-offset depths z^{s}₀′ and z^{p}₀′ may be substantially the same.

In one implementation, the joint tomography process may be performed using the above constraints via a minimization of a cost function using a least squares method, such as:

min_{Δm}|zₕ^{p}′−z₀^{p}′|+|zₕ^{s}′−z₀^{s}′|+|z₀^{s}′−z₀^{p}′| Equation 1

In such an equation, the joint tomography process may minimize the perturbations Δm for the above terms. Minimizing Δm for the terms of the equation may produce a substantially flat updated PP pick 800 between the updated finite-offset depth z^{p}ₕ′ and the updated zero-offset depth z^{p}₀′, a substantially flat updated PS pick 850 between the updated finite-offset depth z^{p}ₕ′ and the updated zero-offset depth z^{p}₀′, and an alignment of the substantially flat updated picks 800 and 850 at their respective updated zero-offset depths.

In another implementation, Equation 1 may be solved via its three block system:

$$\begin{matrix}\begin{matrix}[ \begin{matrix}{A}_{h}^{p} - {A}_{0}^{p} \\ ⋮\end{matrix} ] \\ [ \begin{matrix}{A}_{h}^{s} - {A}_{0}^{s} \\ ⋮\end{matrix} ]\end{matrix} \\ [ \begin{matrix}{A}_{0}^{s} - {A}_{0}^{p} \\ ⋮\end{matrix} ]\end{matrix} Δ m = \begin{matrix}\begin{matrix}[ \begin{matrix}{z}_{0}^{p} \\ ⋮\end{matrix} ] - [ \begin{matrix}{z}_{h}^{p} \\ ⋮\end{matrix} ] \\ [ \begin{matrix}{z}_{0}^{s} \\ ⋮\end{matrix} ] - [ \begin{matrix}{z}_{h}^{s} \\ ⋮\end{matrix} ]\end{matrix} \\ [ \begin{matrix}{z}_{0}^{p} \\ ⋮\end{matrix} ] - [ \begin{matrix}{z}_{0}^{s} \\ ⋮\end{matrix} ]\end{matrix} \qquad Equation 2$$

where Aₕ and A₀ may represent tomographic linear operators as known in the art. Equation 1 may be reduced, such that:

min_{Δm}|zₕ^{p}′−z₀^{p}′|+|zₕ^{s}′−z₀^{p}′| Equation 3

Equation 3 may be solved via the following two block system:

$$\begin{matrix}[ \begin{matrix}{A}_{h}^{p} - {A}_{0}^{p} \\ ⋮\end{matrix} ] \\ [ \begin{matrix}{A}_{h}^{s} - {A}_{0}^{p} \\ ⋮\end{matrix} ]\end{matrix} Δ m = \begin{matrix}[ \begin{matrix}{z}_{0}^{p} \\ ⋮\end{matrix} ] - [ \begin{matrix}{z}_{h}^{p} \\ ⋮\end{matrix} ] \\ [ \begin{matrix}{z}_{0}^{p} \\ ⋮\end{matrix} ] - [ \begin{matrix}{z}_{h}^{s} \\ ⋮\end{matrix} ]\end{matrix} \qquad Equation 4$$

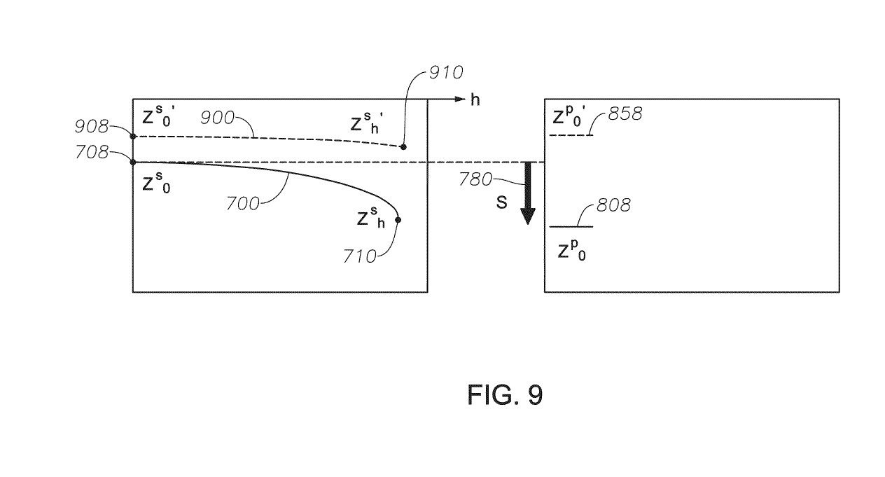

In another implementation, the relative shift in depth determined via the image displacement algorithm may be used by the joint tomography process. FIG. 9 illustrates the PS moveout pick 700 and the relative shift in depth 780 in accordance with implementations of various techniques described herein. As shown in FIG. 9, the farthest left point 708 of the PS moveout pick 700 may represent a PS event plotted at a zero-offset depth z^{s}₀, and the farthest right point 710 of the PS moveout pick 700 may represent a PS event plotted at a finite-offset depth z^{s}ₕ.

The joint tomography process may produce an updated PS pick 900 for the PS moveout pick 700. As shown, the updated PS pick 900 may be depth-shifted such that the updated PS pick 700 may be substantially flat as the offset increases. The farthest left point 908 of the updated PS pick 900 may represent an update to the PS event at point 708, such that the point 908 may be plotted at an updated zero-offset depth z^{s}₀′. Similarly, the farthest right point 910 of the updated PS pick 900 may represent an update to the PS event at point 710, such that the point 860 may be plotted at an updated finite-offset depth z^{s}ₕ′. In such an implementation, the updated PS pick 900 may be constrained by the joint tomography process to be substantially flat, such that a difference in depth between the point 708 plotted at the updated zero-offset depth z^{s}₀′ and the point 710 plotted at the updated finite-offset depth z^{s}ₕ′ may be minimized.

As noted earlier, the depth z^{p}₀ of the hypothetical corresponding PP event 808 of a PP moveout pick (not shown) may be determined by adding a relative shift S to the depth z^{s}₀. In one implementation, an updated event of the hypothetical corresponding PP event 808 may be denoted by the point 858 plotted at an updated offset depth of z^{p}₀′. The joint tomography process may also constrain the updated PS pick 900 to be aligned with this updated offset depth z^{p}₀′, using the equation:

min_{Δm}|zₕ^{s}′−z₀^{p}′|=(zₕ^{s}+Aₕ^{s}Δm)−(z₀^{s}+S+A₀^{p}Δm)| Equation 5

In another implementation, Equation 5 may be solved via its two block system:

$$\begin{matrix}[ \begin{matrix}{A}_{h}^{p} - {A}_{0}^{p} \\ ⋮\end{matrix} ] \\ [ \begin{matrix}{A}_{h}^{s} - {A}_{0}^{s} \\ ⋮\end{matrix} ]\end{matrix} Δ m = \begin{matrix}[ \begin{matrix}{z}_{0}^{p} \\ ⋮\end{matrix} ] - [ \begin{matrix}{z}_{h}^{p} \\ ⋮\end{matrix} ] \\ [ \begin{matrix}{z}_{0}^{s} + S \\ ⋮\end{matrix} ] - [ \begin{matrix}{z}_{h}^{s} \\ ⋮\end{matrix} ]\end{matrix} \qquad Equation 6$$

where Aₕ and A₀ may represent tomographic linear operators as known in the art.

In another such implementation, the joint tomography process may also constrain the updated PS pick 900 to be aligned with this updated offset depth, by the equation:

min_{Δm}|z₀^{s}′−z₀^{p}′|=|(z₀^{s}+A₀^{s}Δm)−(z₀^{s}+S+A₀^{p}Δm)| Equation 7

This equation may be incorporated into the three block system of equation 2, such that

$$\begin{matrix}\begin{matrix}[ \begin{matrix}{A}_{h}^{p} - {A}_{0}^{p} \\ ⋮\end{matrix} ] \\ [ \begin{matrix}{A}_{h}^{s} - {A}_{0}^{s} \\ ⋮\end{matrix} ]\end{matrix} \\ ∝ [ \begin{matrix}{A}_{0}^{s} - {A}_{0}^{p} \\ ⋮\end{matrix} ]\end{matrix} Δ m = \begin{matrix}\begin{matrix}[ \begin{matrix}{z}_{0}^{p} \\ ⋮\end{matrix} ] - [ \begin{matrix}{z}_{h}^{p} \\ ⋮\end{matrix} ] \\ [ \begin{matrix}{z}_{0}^{s} \\ ⋮\end{matrix} ] - [ \begin{matrix}{z}_{h}^{s} \\ ⋮\end{matrix} ]\end{matrix} \\ [ \begin{matrix}S \\ ⋮\end{matrix} ]\end{matrix} \qquad Equation 8$$

where the third block term may be weighted by a factor.

Using the above system of equations, the joint tomography process as disclosed herein may be used to identify the perturbations Δm, where such perturbations may be used to update parameters of the initial model received with respect to block 520.

In one implementation, the updated parameters of the initial model may be used to produce an updated model, such as an updated anisotropic velocity model. In such an implementation, the updated anisotropic velocity model may be modeled by updated parameters Vp, Vs, ε, δ, and/or the like. In such an implementation, the updated model may be used to produce more accurate images of the region. In another implementation, external constraints, such as misties of wells, or any other constraint known to those in the art, may be incorporated into the joint tomography process to further update the model.

In yet another implementation, the updated model may be further updated by iteratively performing one or more blocks of the method 500 using the updated model. For example, a migration of block 530 may be performed using the updated model to produce a first set of updated gathers and a second set of updated gathers. Based on the curvature of the events of the updated gathers, one or more other blocks of the method 500 may be performed in order to further update the model.

As noted above, by calculating updates to the initial model by minimizing residual moveout on a first and second set of gathers, while also minimizing a depth mismatch between the two sets of gathers, the joint tomography process may provide constraints on the parameters of the initial model such that a more accurate model of the region of interest may be developed, thereby producing a more accurate image of the region. Further, performing a joint tomography process may allow for a quicker updating of the initial model when compared to updating the model using separate tomography processes for multiple sets of data.

In some implementations, a method for seismic data processing using joint tomography may be provided. The method may receive seismic data corresponding to a region of interest. The method may generate one or more first gathers and one or more second gathers based on the seismic data. The method may determine a relative shift in depth between at least a first event in the one or more first gathers and at least a second event in the one or more second gathers. The method may perform a joint tomography based at least in part on the first event, the second event, and the determined relative shift.

In some implementations, the method may perform the joint tomography using a first moveout pick of the first event and a second moveout pick of the second event. The method may also produce an updated pick of the first moveout pick and an updated pick of the second moveout pick. The updated pick of the first moveout pick and the updated pick of the second moveout pick may be aligned at substantially the same depth and may be substantially flat. The joint tomography may also minimize perturbations of an initial model corresponding to the region of interest based on at least the updated pick of the first moveout pick and at least the updated pick of the second moveout pick. The method may receive an initial model corresponding to the region of interest and update the initial model based on the joint tomography. The method may also solve for perturbations of the initial model and update parameters of the initial model based on the perturbations. The method may perform a migration on the received seismic data in conjunction with an initial model corresponding to the region of interest. The first event and the second event may be corresponding events. The method may determine the relative shift automatically using an image displacement algorithm. The method may also identify a depth of a corresponding hypothetical event based on the image displacement algorithm.

In some implementations, an information processing apparatus for use in a computing system is provided, and includes means for receiving seismic data corresponding to a region of interest. The information processing apparatus may also have means for generating one or more first gathers and one or more second gathers based on the seismic data. The information processing apparatus may also have means for determining a relative shift in depth between at least a first event in the one or more first gathers and at least a second event in the one or more second gathers. The information processing apparatus may also have means for performing a joint tomography based at least in part on the first event, the second event, and the determined relative shift.

In some implementations, a computing system is provided that includes at least one processor, at least one memory, and one or more programs stored in the at least one memory, wherein the programs include instructions, which when executed by the at least one processor cause the computing system to receive seismic data corresponding to a region of interest. The programs may further include instructions to cause the computing system to generate one or more first gathers and one or more second gathers based on the seismic data. The programs may further include instructions to cause the computing system to determine a relative shift in depth between at least a first event in the one or more first gathers and at least a second event in the one or more second gathers. The programs may further include instructions to cause the computing system to perform a joint tomography based at least in part on the first event, the second event, and the determined relative shift.

In some implementations, a computer readable storage medium is provided, which has stored therein one or more programs, the one or more programs including instructions, which when executed by a processor, cause the processor to receive seismic data corresponding to a region of interest. The programs may further include instructions, which cause the processor to generate one or more first gathers and one or more second gathers based on the seismic data. The programs may further include instructions, which cause the processor to determine a relative shift in depth between at least a first event in the one or more first gathers and at least a second event in the one or more second gathers. The programs may further include instructions, which cause the processor to perform a joint tomography based at least in part on the first event, the second event, and the determined relative shift. The programs may further include instructions, where the one or more first gathers include surface seismic gathers and the one or more second gathers include vertical seismic profile gathers.

In some implementations, a method for seismic data processing using joint tomography may be provided. The method may receive seismic data corresponding to a region of interest. The method may generate one or more PP gathers and one or more PS gathers based on the seismic data. The method may determine a relative shift in depth between at least a PP event in the one or more PP gathers and at least a PS event in the one or more PS gathers. The method may perform a joint tomography based at least in part on the PP event, the PS event, and the determined relative shift.

In some implementations, the method may perform the joint tomography using a first moveout pick of the PP event and a second moveout pick of the PS event. The method may also produce an updated pick of the first moveout pick and an updated pick of the second moveout pick. The updated pick of the first moveout pick and the updated pick of the second moveout pick may be aligned at substantially the same depth and may be substantially flat. The method may also minimize perturbations of an initial model corresponding to the region of interest based on at least the updated pick of the first moveout pick and at least the updated pick of the second moveout pick. The method may receive an initial model corresponding to the region of interest and update the initial model based on the joint tomography. The method may also solve for perturbations of the initial model and update parameters of the initial model based on the perturbations.

In some implementations, an information processing apparatus for use in a computing system is provided, and includes means for receiving seismic data corresponding to a region of interest. The information processing apparatus may also have means for generating one or more PP gathers and one or more PS gathers based on the seismic data. The information processing apparatus may also have means for determining a relative shift in depth between at least a PP event in the one or more PP gathers and at least a PS event in the one or more PS gathers. The information processing apparatus may also have means for performing a joint tomography based at least in part on the PP event, the PS event, and the determined relative shift.

In some implementations, a computing system is provided that includes at least one processor, at least one memory, and one or more programs stored in the at least one memory, wherein the programs include instructions, which when executed by the at least one processor cause the computing system to receive seismic data corresponding to a region of interest. The programs may further include instructions to cause the computing system to generate one or more PP gathers and one or more PS gathers based on the seismic data. The programs may further include instructions to cause the computing system to determine a relative shift in depth between at least a PP event in the one or more PP gathers and at least a PS event in the one or more PS gathers. The programs may further include instructions to cause the computing system to perform a joint tomography based at least in part on the PP event, the PS event, and the determined relative shift.

In some implementations, a computer readable storage medium is provided, which has stored therein one or more programs, the one or more programs including instructions, which when executed by a processor, cause the processor to receive seismic data corresponding to a region of interest. The programs may further include instructions, which cause the processor to generate one or more PP gathers and one or more PS gathers based on the seismic data. The programs may further include instructions, which cause the processor to determine a relative shift in depth between at least a PP event in the one or more PP gathers and at least a PS event in the one or more PS gathers. The programs may further include instructions, which cause the processor to perform a joint tomography based at least in part on the PP event, the PS event, and the determined relative shift.

### Computing Systems

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smartphones, smartwatches, personal wearable computing systems networked with other computing systems, tablet computers, and distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc., that performs particular tasks or implement particular abstract data types. While program modules may execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may also be implemented in distributed computing environments where tasks are performed by remote processing devices that are linked through a communications network, e.g., by hardwired links, wireless links, or combinations thereof. The distributed computing environments may span multiple continents and multiple vessels, ships or boats. In a distributed computing environment, program modules may be located in both local and remote computer storage media including memory storage devices.

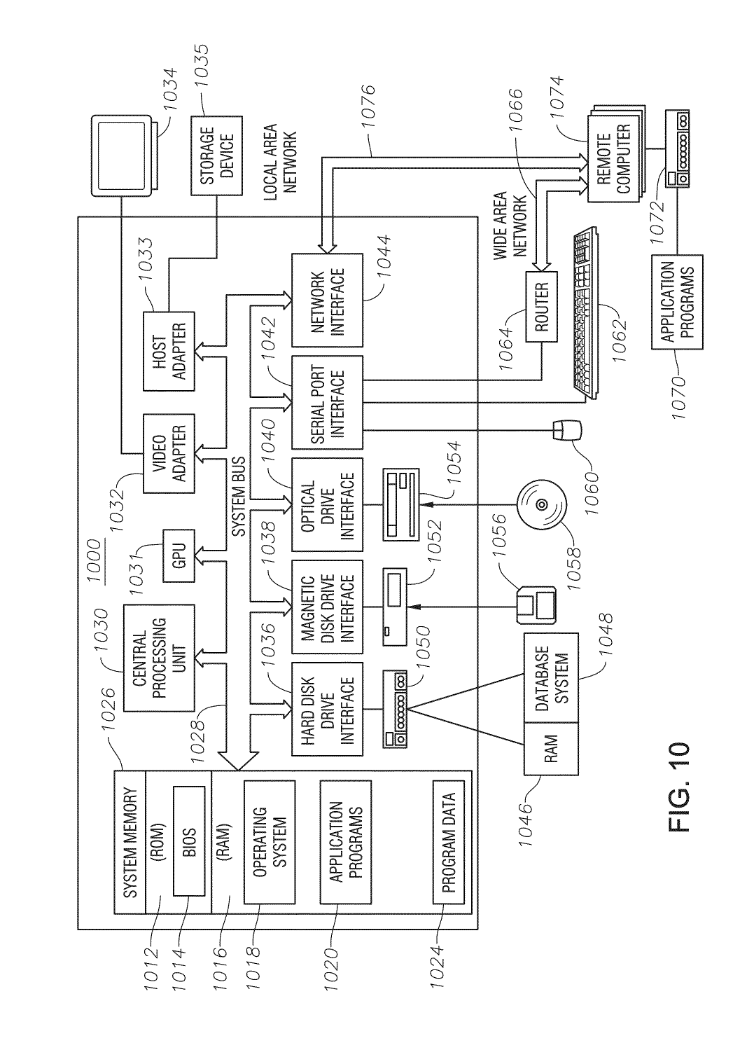

FIG. 10 illustrates a schematic diagram of a computing system 1000 in which the various technologies described herein may be incorporated and practiced. Although the computing system 1000 may be a conventional desktop or a server computer, as described above, other computer system configurations may be used.

The computing system 1000 may include a central processing unit (CPU) 1030, a system memory 1026, a graphics processing unit (GPU) 1031 and a system bus 1028 that couples various system components including the system memory 1026 to the CPU 1030. Although one CPU is illustrated in FIG. 10, it should be understood that in some implementations the computing system 1000 may include more than one CPU. The GPU 1031 may be a microprocessor specifically designed to manipulate and implement computer graphics. The CPU 1030 may offload work to the GPU 1031. The GPU 1031 may have its own graphics memory, and/or may have access to a portion of the system memory 1026. As with the CPU 1030, the GPU 1031 may include one or more processing units, and the processing units may include one or more cores. The system bus 1028 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 1026 may include a read-only memory (ROM) 1012 and a random access memory (RAM) 1046. A basic input/output system (BIOS) 1014, containing the basic routines that help transfer information between elements within the computing system 1000, such as during start-up, may be stored in the ROM 1012.

The computing system 1000 may further include a hard disk drive 1050 for reading from and writing to a hard disk, a magnetic disk drive 1052 for reading from and writing to a removable magnetic disk 1056, and an optical disk drive 1054 for reading from and writing to a removable optical disk 1058, such as a CD ROM or other optical media. The hard disk drive 1050, the magnetic disk drive 1052, and the optical disk drive 1054 may be connected to the system bus 1028 by a hard disk drive interface 1056, a magnetic disk drive interface 1058, and an optical drive interface 1050, respectively. The drives and their associated computer-readable media may provide nonvolatile storage of computer-readable instructions, data structures, program modules and other data for the computing system 1000.

Although the computing system 1000 is described herein as having a hard disk, a removable magnetic disk 1056 and a removable optical disk 1058, it should be appreciated by those skilled in the art that the computing system 1000 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 1000. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The computing system 1000 may also include a host adapter 1033 that connects to a storage device 1035 via a small computer system interface (SCSI) bus, a Fiber Channel bus, an eSATA bus, or using any other applicable computer bus interface. Combinations of any of the above may also be included within the scope of computer readable media.

A number of program modules may be stored on the hard disk 1050, magnetic disk 10510, optical disk 1058, ROM 1012 or RAM 1016, including an operating system 1018, one or more application programs 1020, program data 1024, and a database system 1048. The application programs 1020 may include various mobile applications (“apps”) and other applications configured to perform various methods and techniques described herein. The operating system 1018 may be any suitable operating system that may control the operation of a networked personal or server computer, such as Windows® XP, Mac OS® X, Unix-variants (e.g., Linux® and BSD®), and the like.

A user may enter commands and information into the computing system 1000 through input devices such as a keyboard 1062 and pointing device 1060. Other input devices may include a microphone, joystick, game pad, satellite dish, scanner, or the like. These and other input devices may be connected to the CPU 1030 through a serial port interface 1042 coupled to system bus 1028, but may be connected by other interfaces, such as a parallel port, game port or a universal serial bus (USB). A monitor 1034 or other type of display device may also be connected to system bus 1028 via an interface, such as a video adapter 1032. In addition to the monitor 1034, the computing system 1000 may further include other peripheral output devices such as speakers and printers.

Further, the computing system 1000 may operate in a networked environment using logical connections to one or more remote computers 1074. The logical connections may be any connection that is commonplace in offices, enterprise-wide computer networks, intranets, and the Internet, such as local area network (LAN) 1056 and a wide area network (WAN) 1066. The remote computers 1074 may be another a computer, a server computer, a router, a network PC, a peer device or other common network node, and may include many of the elements describes above relative to the computing system 1000. The remote computers 1074 may also each include application programs 1070 similar to that of the computer action function.

When using a LAN networking environment, the computing system 1000 may be connected to the local network 1076 through a network interface or adapter 1044. When used in a WAN networking environment, the computing system 1000 may include a router 1064, wireless router or other means for establishing communication over a wide area network 1066, such as the Internet. The router 1064, which may be internal or external, may be connected to the system bus 1028 via the serial port interface 1052. In a networked environment, program modules depicted relative to the computing system 1000, or portions thereof, may be stored in a remote memory storage device 1072. It will be appreciated that the network connections shown are merely examples and other means of establishing a communications link between the computers may be used.

The network interface 1044 may also utilize remote access technologies (e.g., Remote Access Service (RAS), Virtual Private Networking (VPN), Secure Socket Layer (SSL), Layer 2 Tunneling (L2T), or any other suitable protocol). These remote access technologies may be implemented in connection with the remote computers 1074.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations. Also, the program code may execute entirely on a user's computing device, on the user's computing device, as a stand-alone software package, on the user's computer and on a remote computer or entirely on the remote computer or a server computer.

The system computer 1000 may be located at a data center remote from the survey region. The system computer 1000 may be in communication with the receivers (either directly or via a recording unit, not shown), to receive signals indicative of the reflected seismic energy. These signals, after conventional formatting and other initial processing, may be stored by the system computer 1000 as digital data in the disk storage for subsequent retrieval and processing in the manner described above. In one implementation, these signals and data may be sent to the system computer 1000 directly from sensors, such as geophones, hydrophones and the like. When receiving data directly from the sensors, the system computer 1000 may be described as part of an in-field data processing system. In another implementation, the system computer 1000 may process seismic data already stored in the disk storage. When processing data stored in the disk storage, the system computer 1000 may be described as part of a remote data processing center, separate from data acquisition. The system computer 1000 may be configured to process data as part of the in-field data processing system, the remote data processing system or a combination thereof.

Those with skill in the art will appreciate that any of the listed architectures, features or standards discussed above with respect to the example computing system 1000 may be omitted for use with a computing system used in accordance with the various embodiments disclosed herein because technology and standards continue to evolve over time.

Those with skill in the art will also appreciate that in the example of workflow 500, that shifts between specific PP and PS events on gathers have to be picked manually. Rather, in some embodiments, a continuous (or substantially continuous) shift field with respect to a plurality of events that can be matched is determined, then applied to the PP and PS gathers or other data types on which joint tomography will be applied to.

Moreover, while some implementations disclosed herein operate with respect to parameters such as Vp, Vs, ε, and δ, those with skill in the art will appreciate that this does not mean that the methods and techniques disclosed herein are limited to transversely isotropic cases. Rather, skilled artisans may apply the techniques discussed herein in isotropic, orthorhombic, monoclinic, or triclinic and/or other general cases.

The steps in the processing methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of protection of the implementations described herein.

Of course, many processing techniques for collected data, including one or more of the techniques and methods disclosed herein, may also be used successfully with collected data types other than seismic data. While certain implementations have been disclosed in the context of seismic data collection and processing, those with skill in the art will recognize that one or more of the methods, techniques, and computing systems disclosed herein can be applied in many fields and contexts where data involving structures arrayed in a multi-dimensional space and/or subsurface region of interest may be collected and processed, e.g., medical imaging techniques such as tomography, ultrasound, MRI and the like for human tissue; radar, sonar, and LIDAR imaging techniques; mining area surveying and monitoring, oceanographic surveying and monitoring, and other appropriate multi-dimensional imaging problems.

In some implementations, the multi-dimensional region of interest is selected from the group consisting of a subterranean region, human tissue, plant tissue, animal tissue, solid volumes, substantially solid volumes, volumes of liquid, volumes of gas, volumes of plasma, and volumes of space near and/or outside the atmosphere of a planet, asteroid, comet, moon, or other body.

The foregoing description, for purpose of explanation, has been described with reference to specific implementations. However, the illustrative discussions above are not intended to be exhaustive or to limit the above-described implementations to the precise forms disclosed. Many modifications and variations are possible in view of the above teachings. The implementations were chosen and described in order to explain the principles of the above-described implementations and their practical applications, to thereby enable others skilled in the art to best utilize the above-described implementations with various modifications as are suited to the particular use contemplated.

What is claimed is:

1. A method for processing seismic data, comprising:
receiving seismic data corresponding to a region of interest;
generating one or more first gathers and one or more second gathers based on the seismic data;
determining a relative shift in depth between at least a first event in the one or more first gathers and at least a second event in the one or more second gathers; and
performing a joint tomography based at least in part on the first event, the second event, and the determined relative shift.

2. The method of claim 1, further comprising performing the joint tomography using a first moveout pick of the first event and a second moveout pick of the second event.

3. The method of claim 2, wherein performing the joint tomography comprises producing an updated pick of the first moveout pick and an updated pick of the second moveout pick.

4. The method of claim 3, wherein the updated pick of the first moveout pick and the updated pick of the second moveout pick are aligned at substantially the same depth and are substantially flat.

5. The method of claim 3, wherein the joint tomography minimizes perturbations of an initial model corresponding to the region of interest based on at least the updated pick of the first moveout pick and at least the updated pick of the second moveout pick.

6. The method of claim 1, further comprising:
receiving an initial model corresponding to the region of interest; and
updating the initial model based on the joint tomography.

7. The method of claim 6, further comprising:
solving for perturbations of the initial model;
updating parameters of the initial model based on the perturbations.

8. The method of claim 1, wherein generating the one or more first gathers and the one or more second gathers comprises performing a migration on the received seismic data in conjunction with an initial model corresponding to the region of interest.

9. The method of claim 1, wherein the first event and the second event are corresponding events.

10. The method of claim 1, wherein determining the relative shift in depth comprises determining the relative shift automatically using an image displacement algorithm.

11. The method of claim 10, further comprising identifying a depth of a corresponding hypothetical event based on the image displacement algorithm.

12. A method for processing seismic data, comprising:
receiving seismic data corresponding to a region of interest;
generating one or more PP gathers and one or more PS gathers based on the seismic data;
determining a relative shift in depth between at least a PP event in the one or more PP gathers and at least a PS event in the one or more PS gathers; and
performing a joint tomography based at least in part on the PP event, the PS event, and the determined relative shift.

13. The method of claim 12, further comprising performing the joint tomography using a first moveout pick of the PP event and a second moveout pick of the PS event.

14. The method of claim 13, wherein performing the joint tomography comprises producing an updated pick of the first moveout pick and an updated pick of the second moveout pick.

15. The method of claim 14, wherein the updated pick of the first moveout pick and the updated pick of the second moveout pick are aligned at substantially the same depth and are substantially flat.

16. The method of claim 14, wherein the joint tomography minimizes perturbations of an initial model corresponding to the region of interest based on at least the updated pick of the first moveout pick and at least the updated pick of the second moveout pick.

17. The method of claim 12, further comprising:
receiving an initial model corresponding to the region of interest; and
updating the initial model based on the joint tomography.

18. The method of claim 17, further comprising:
solving for perturbations of the initial model;
updating parameters of the initial model based on the perturbations.

19. A non-transitory computer-readable medium having stored thereon a plurality of computer-executable instructions which, when executed by a computer, cause the computer to:
receive seismic data corresponding to a region of interest;
generate one or more first gathers and one or more second gathers based on the seismic data;
determine a relative shift in depth between at least a first event in the one or more first gathers and at least a second event in the one or more second gathers; and
perform a joint tomography based at least in part on the first event, the second event, and the determined relative shift.

20. The non-transitory computer-readable medium of claim 19, wherein the one or more first gathers comprise surface seismic gathers and wherein the one or more second gathers comprise vertical seismic profile gathers.
